(19) United States
(12) Patent Application Publication
(10) Pub. No.: US 2014/0298201 A1
(43) Pub. Date: Oct. 2, 2014

(54) METHOD FOR PERFORMING MERGING CONTROL OF FEEDS ON AT LEAST ONE SOCIAL NETWORK, AND ASSOCIATED APPARATUS AND ASSOCIATED COMPUTER PROGRAM PRODUCT

(71) Applicant: HTC CORPORATION, Taoyuan County (TW)

(72) Inventors: Yuan-Mao Tsui, Taoyuan County (TW); Yi-Shan Lin, Taoyuan County (TW)

(73) Assignee: HTC CORPORATION, Taoyuan County (TW)

(21) Appl. No.: 13/854,149

(22) Filed: Apr. 1, 2013

(51) Int. Cl. G06F 3/0484

(52) U.S. Cl. CPC G06F 3/0484
USPC 715/753

(57) ABSTRACT

A method for performing merging control of feeds on at least one social network and associated apparatus and computer program product are provided, where the method includes: collecting all feeds of at least one account of a user on the at least one social network, the feeds generated during a predetermined time period, comparing the collected feeds to find related feeds corresponding to at least one same topic within the collected feeds, and merging the related feeds corresponding to the at least one same topic into at least one merged feed; and listing the at least one merged feed and remaining feeds within the collected feeds, rather than listing all of the related feeds corresponding to the at least one same topic, to generate a feed list to be viewed, wherein in the feed list, the at least one merged feed is ranked to be viewed by the user first.

### BACKGROUND OF THE INVENTION

1. Field of the Invention

The present invention relates to feed merging of one or more social networks for a user of a portable electronic device, and more particularly, to a method for performing merging control of feeds on at least one social network, and to an associated apparatus and an associated computer program product.

2. Description of the Prior Art

There are many social networks available for users to use. According to the related art, a portable electronic device such as a multifunctional mobile phone can provide the user thereof with a service of accessing his/her own accounts on different social networks through the portable electronic device. When the user temporarily stop using his/her accounts on these social networks for a period (e.g. one or more weeks), some problems may occur. For example, the user may have a tour abroad without activating any roaming service during this period, and his/her friends may discuss something regarding a special event on the social networks, causing some repeated or similar feeds corresponding to the same topic to be generated. As a result, when the user comes back, he/she may be forced to read these repeated or similar feeds corresponding to the same topic. Thus, the related art does not serve the user well, and therefore a novel method is required for enhancing user experience of using the social networks.

### SUMMARY OF THE INVENTION

It is an objective of the claimed invention to provide a method for performing merging control of feeds on at least one social network, and to provide an associated apparatus and an associated computer program product, in order to solve the above-mentioned problems.

According to at least one preferred embodiment, a method for performing merging control of feeds on at least one social network is provided, where the method is applied to an electronic device. The method comprises the steps of: collecting all feeds of at least one account of a user of the electronic device on the at least one social network, the feeds generated during a predetermined time period, comparing the collected feeds to find related feeds corresponding to at least one same topic within the collected feeds, and merging the related feeds corresponding to the at least one same topic into at least one merged feed; and listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.

According to at least one preferred embodiment, an apparatus for performing merging control of feeds on at least one social network is also provided, where the apparatus comprises at least one portion of an electronic device. The apparatus comprises a processing circuit comprising at least one processor arranged to execute program instructions to perform operations according a method comprising the steps of: collecting all feeds of at least one account of a user of the electronic device on the at least one social network, the feeds generated during a predetermined time period, comparing the collected feeds to find related feeds corresponding to at least one same topic within the collected feeds, and merging the related feeds corresponding to the at least one same topic into at least one merged feed; and listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.

According to at least one preferred embodiment, a computer program product is also provided, where the computer program product has program instructions for instructing a processor of an electronic device to perform a method comprising the steps of: collecting all feeds of at least one account of a user of the electronic device on at least one social network, the feeds generated during a predetermined time period, comparing the collected feeds to find related feeds corresponding to at least one same topic within the collected feeds, and merging the related feeds corresponding to the at least one same topic into at least one merged feed; and listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.

It is an advantage of the present invention that the aforementioned method, the aforementioned apparatus, and the aforementioned computer program product allow the user to simply view the aforementioned at least one merged feed (e.g. one or more merged feeds), having no need to read the aforementioned repeated or similar feeds corresponding to the same topic. In addition, in a situation where the topics are many, the aforementioned method, the aforementioned apparatus, and the aforementioned computer program product can help the user to rapidly understand with ease the topics that his/her friends are involved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing merging control of feeds on at least one social network according to an example.

FIG. 2 illustrates an electronic device involved with the apparatus shown in FIG. 1 according to an example, where the apparatus of this example can be a mobile device.

FIG. 3 illustrates a flowchart of a method for performing merging control of feeds on at least one social network according to an example.

FIG. 4 illustrates a feed list involved with the method shown in FIG. 3 according to an example.

FIG. 5 illustrates a working flow involved with the method shown in FIG. 3 according to an example.

### DETAILED DESCRIPTION

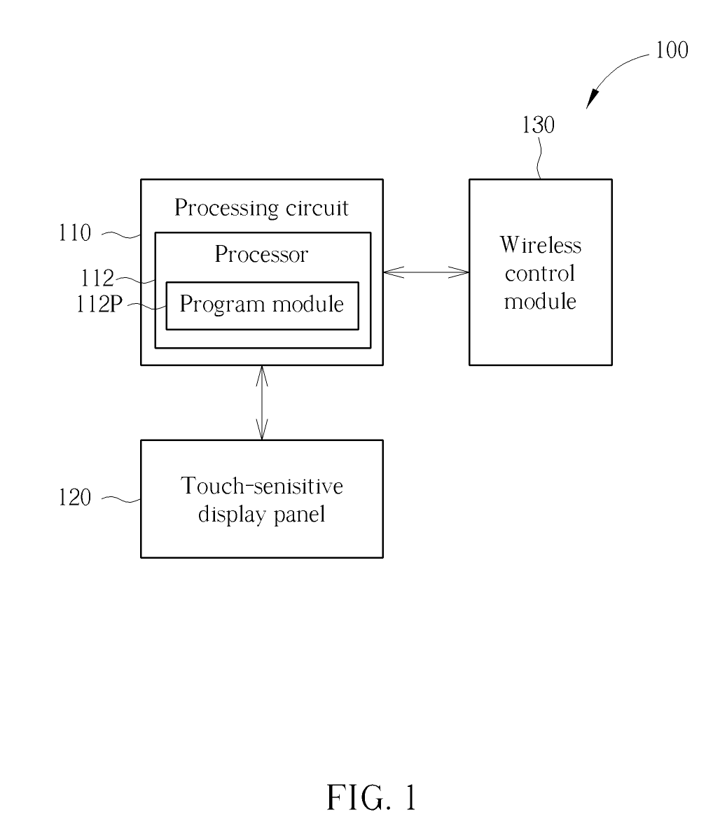

FIG. 1 is a diagram of an apparatus 100 for performing merging control of feeds on at least one social network according to an example, where the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. Examples of the electronic device may include, but not limited to, a mobile phone (e.g. a multifunctional mobile phone), a mobile computer (e.g. tablet computer), a personal digital assistant (PDA), and a personal computer such as a laptop computer or desktop computer.

As shown in FIG. 1, the apparatus 100 comprises a non-volatile memory 50 (labeled “NV”, for brevity) such as a Flash memory, a processing circuit 110, a touch-sensitive display panel 120, and a wireless control circuit 130, which is typically coupled to an antenna such as that shown in FIG. 1, where the processing circuit 110 is arranged to control operations of the electronic device, and the wireless control circuit 130 is arranged to perform wireless control for the electronic device. Please note that the processing circuit 110 can be selectively implemented with the mixed scheme utilizing software (or firmware) module running on hardware circuit(s), such as that shown in FIG. 1. For example, the processing circuit 110 may comprise at least one processor 112 and associated hardware circuits implemented by using at least one printed circuit board (PCB) on which the processor can be installed, and the aforementioned associated hardware circuits may comprise at least one memory (not shown) such as at least one random access memory (RAM) and/or at least one non-volatile memory (e.g. an electrically erasable programmable read only memory (EEPROM) or a Flash memory), where at least one program module 112P comprising program instructions to be executed by the aforementioned at least one processor 112 may be stored in a storage unit such as the aforementioned at least one non-volatile memory in the processing circuit 110 or the non-volatile memory 50 in advance and retrieved by the processing circuit 110 (more particularly, the aforementioned at least one processor 112), for running on the processing circuit 110 as illustrated in FIG. 1. This is for illustrative purposes only, and is not meant to be a limitation. In another example, the processing circuit 110 may be implemented as pure hardware circuit(s), where the aforementioned at least one program module 112P can be imbedded therein.

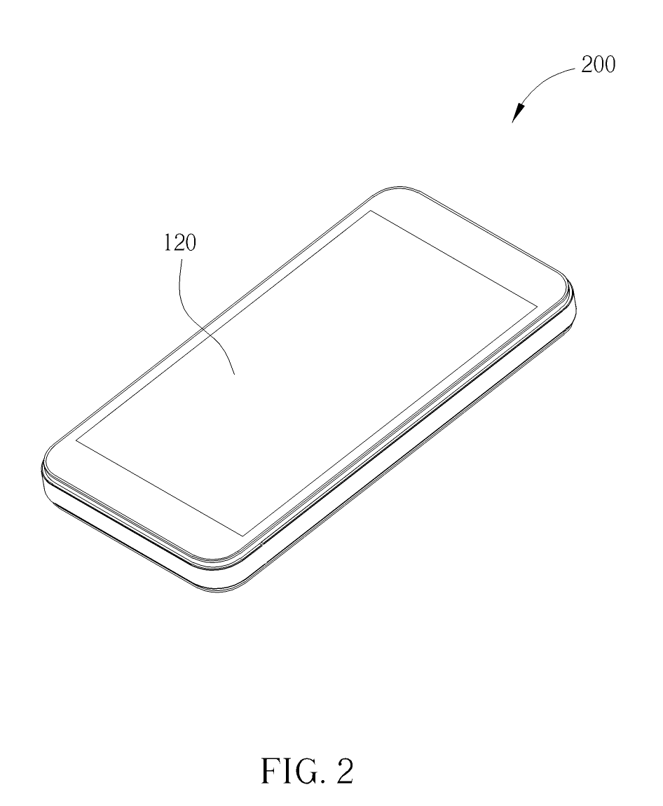

FIG. 2 illustrates an electronic device involved with the apparatus 100 shown in FIG. 1 according to an example, where the apparatus 100 of this example can be a mobile phone 200. Thus, the apparatus 100 comprises the whole of the mobile phone 200 in this example.

Under control of the aforementioned at least one processor 112 executing the aforementioned at least one program module 112P, the mobile phone 200 can provide the user with a feed merging and ranking service to filter or to highlight the hottest topic(s) between the user's friends on social networks. In this example, under control of the aforementioned at least one processor 112 executing the aforementioned at least one program module 112P, the mobile phone 200 allows the user to set at least one predetermined time period corresponding to the feed merging and ranking service, such as the time duration or the time period when the feeds to be processed by the feed merging and ranking service are generated, where the feeds can also be referred to as social feeds or social updates. For example, in a situation where the user just comes back from a tour such as that mentioned above, the user may set a predetermined time period for ranking the feeds on social networks (or the services thereof) that the user logs in to be the past seven days, i.e. the time period starting from one week ago to the time point of setting this predetermined time period. Regarding filtering, once the predetermined time period is set, the aforementioned at least one processor 112 executing the aforementioned at least one program module 112P may collect all feeds of the user's accounts (for example, the accounts on Twitter and Facebook) during this predetermined time period. When all the feeds under consideration, such as the feeds generated during the predetermined time period, are collected, the aforementioned at least one processor 112 executing the aforementioned at least one program module 112P may first compare all of these feeds to find high correlation feeds (more particularly, the related feeds corresponding to the same topic) by parsing the keywords in each feed of at least one portion (e.g. a portion or all) of these feeds and/or by parsing the shared or mentioned Uniform Resource Locator (URL) content, and then merge the related feeds corresponding to the same topic as one feed.

In practice, the aforementioned at least one processor 112 executing the aforementioned at least one program module 112P may perform ranking to generate a feed list to be viewed by the user, such as the list of feeds filtered by correlation, where the feed list can be referred to as the “filtered-by-correlation” feed list. When generating the feed list, the aforementioned at least one processor 112 executing the aforementioned at least one program module 112P may use the number of feeds labeled with any of Like, Favorite, Comment, Retweet, Reply, or Share within the related feeds corresponding to the same topic as a ranking index to rank the feeds in the feed list. As a result, the feeds in the feed list are ranked, and there is no repeated or duplicated feed in the feed list, where the merged feed with the highest number of original feeds (i.e. the feeds that are merged to generate this merged feed) labeled with any of Like, Favorite, Comment, Retweet, Reply, or Share may be the prioritized in the feed list according to the ranking index thereof.

In addition, some implementation details regarding prioritization can be described as follows. In the final ranked feed list, for any merged feed, the aforementioned at least one processor 112 executing the aforementioned at least one program module 112P may check the frequency of each social network (or the service thereof) that the user uses, and more particularly, may check which of the social networks (or the services thereof) is the one that the user uses more frequently than other(s), for example, based on the frequency of the corresponding social network mobile application launched on the electronic device such as the mobile phone 200, and further control the touch-sensitive display panel 120 to display that service's feed as the merged feed in the final feed list. For example, there are feeds (or social feeds or social updates) talking about US election both in Facebook and Twitter, and the user actually checks Facebook (more particularly, check with the Facebook application) more frequently than Twitter. In this example, the aforementioned at least one processor 112 executing the aforementioned at least one program module 112P utilizes one of the feeds (or social feeds or social updates) talking about US election on Facebook, rather than any of the feeds (or social feeds or social updates) talking about US election on Twitter, as the merged feed for the same topic of US election, and control the touch-sensitive display panel 120 to display this merged feed in the feed list.

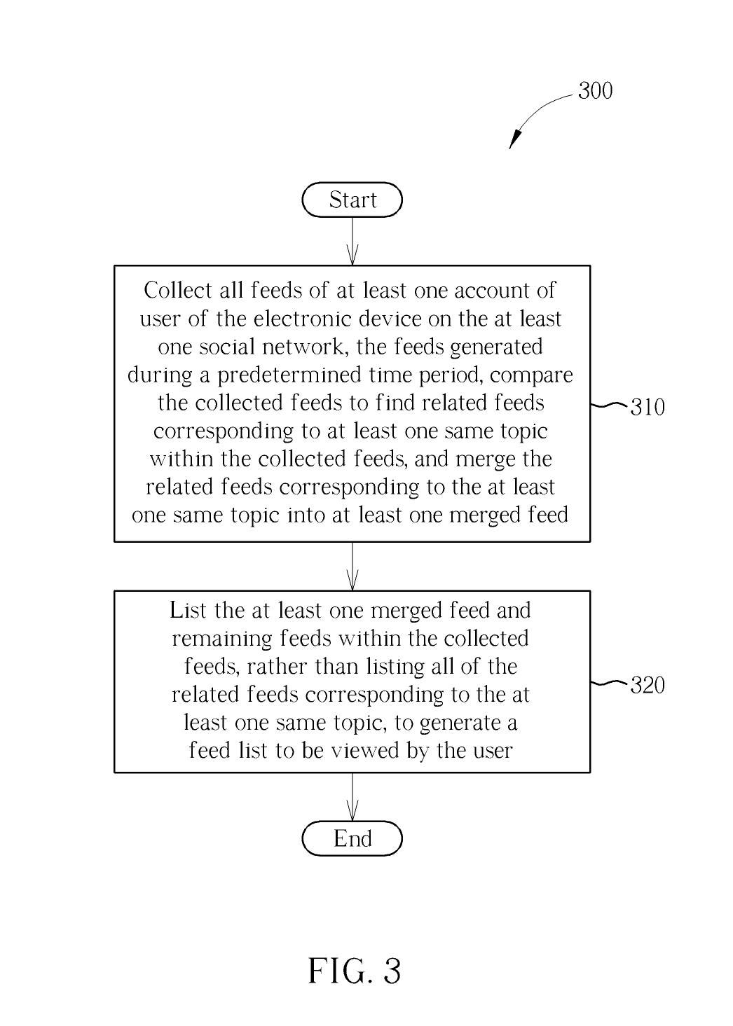

FIG. 3 illustrates a flowchart of a method 300 for performing merging control of feeds on at least one social network according to an example. The method shown in FIG. 3 can be applied to the apparatus 100 shown in FIG. 1 (more particularly, the mobile device 200 of the example shown in FIG. 2), and can be applied to the processing circuit 110 thereof (more particularly, the aforementioned at least one processor 112 executing the aforementioned at least one program module 112P). For example, the aforementioned at least one program module 112P may be provided through a computer program product having the program instructions for instructing the processor 112 to perform the method 300 shown in FIG. 3, where the computer program product may be implemented as a non-transitory computer-readable medium (e.g. a floppy disk or a compact disc-read only memory (CD-ROM)) storing the program instructions or an equivalent version thereof, such as a software package for being installed. The method is described as follows.

In Step 310, the aforementioned at least one processor 112 executing the aforementioned at least one program module 112P collects all feeds of at least one account (e.g. one or more accounts) of the user of the electronic device on the aforementioned at least one social network (e.g. one or more social networks), the feeds generated during a predetermined time period such as that mentioned above, compares the collected feeds to find related feeds corresponding to at least one same topic within the collected feeds, and merges the related feeds corresponding to the aforementioned at least one same topic into at least one merged feed. For example, regarding comparing the collected feeds to find the related feeds corresponding to the at least one same topic within the collected feeds, the aforementioned at least one processor 112 executing the aforementioned at least one program module 112P may parse keywords of the collected feeds to find the related feeds corresponding to the aforementioned at least one same topic within the collected feeds. In another example, regarding comparing the collected feeds to find the related feeds corresponding to the at least one same topic within the collected feeds, the aforementioned at least one processor 112 executing the aforementioned at least one program module 112P may parse URL contents shared or mentioned in the collected feeds to find the related feeds corresponding to the aforementioned at least one same topic within the collected feeds.

In Step 320, the aforementioned at least one processor 112 executing the aforementioned at least one program module 112P lists the aforementioned at least one merged feed and remaining feeds within the collected feeds, rather than listing all of the related feeds corresponding to the aforementioned at least one same topic, to generate a feed list to be viewed by the user, such as the feed list mentioned above, where in the feed list, the aforementioned at least one merged feed is ranked to be viewed by the user first. More particularly, the feed list may comprise the aforementioned at least one merged feed and the remaining feeds, such as all of the contents of the aforementioned at least one merged feed and the remaining feeds. For example, the aforementioned at least one processor 112 executing the aforementioned at least one program module 112P may utilize the number of feeds labeled with any of Like, Favorite, Comment, Retweet, Reply, or Share within the related feeds corresponding to the at least one same topic as a ranking index of the at least one merged feed. In a situation where the aforementioned at least one merged feed comprises a plurality of merged feeds, for each merged feed of the plurality of merged feeds, the aforementioned at least one processor 112 executing the aforementioned at least one program module 112P typically utilizes the number of feeds labeled with any of Like, Favorite, Comment, Retweet, Reply, or Share within the related feeds corresponding to the same topic of the aforementioned each merged feed as the ranking index of the aforementioned each merged feed. Within the plurality of merged feeds, the merged feed whose ranking index is greater than other(s) is ranked to be viewed by the user first. As a result, in the feed list, any of the aforementioned at least one merged feed and any of the remaining feeds correspond to different topics, respectively.

According to this example, regarding merging the related feeds corresponding to the at least one same topic into the at least one merged feed, the aforementioned at least one processor 112 executing the aforementioned at least one program module 112P may utilize one of the related feeds corresponding to the aforementioned at least one same topic as the aforementioned at least one merged feed. More particularly, the aforementioned at least one social network may comprise a plurality of social networks, and the aforementioned at least one processor 112 executing the aforementioned at least one program module 112P may check the frequencies of running a plurality of social network applications corresponding to the plurality of social networks on the electronic device, respectively, to determine a specific social network that the user uses more frequently than other(s) within the plurality of social networks. Thus, in a situation where the related feeds corresponding to the aforementioned at least one same topic comprise feeds on the plurality of social networks, respectively, the aforementioned at least one processor 112 executing the aforementioned at least one program module 112P typically utilizes a feed on the specific social network, the feed corresponding to the aforementioned at least one same topic, as the aforementioned at least one merged feed.

In practice, under control of the aforementioned at least one processor 112 executing the aforementioned at least one program module 112P, the mobile phone 200 can provide the user with a setting mechanism (e.g. a dialog window provided through the user interface implemented with the touch-sensitive display panel 120), allowing the user to determine the predetermined time period in advance. In addition,

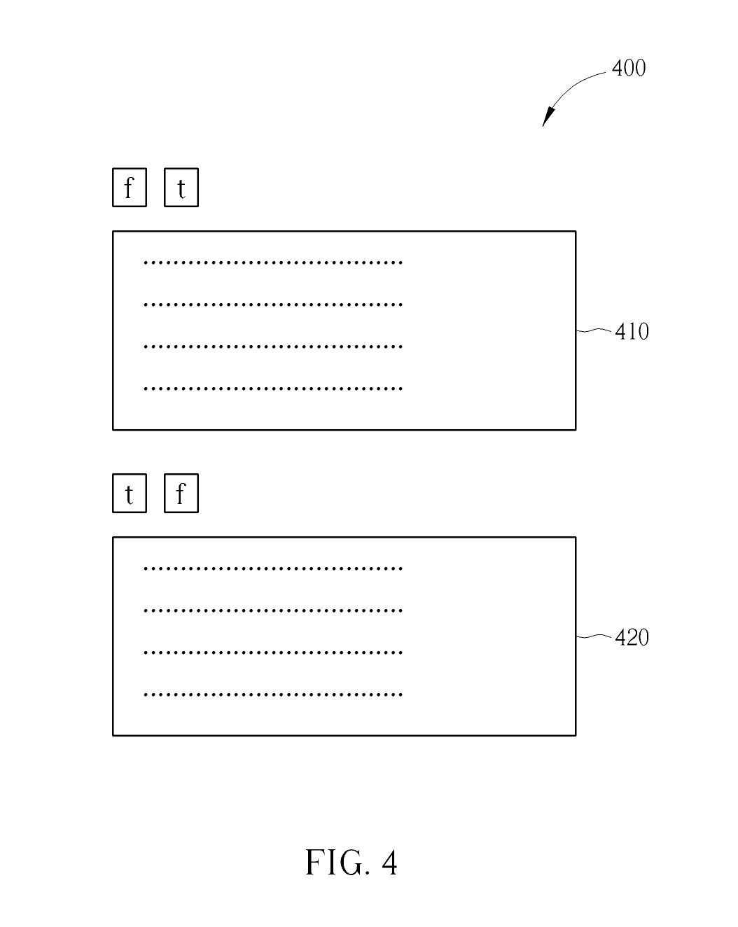

FIG. 4 illustrates a feed list 400 involved with the method 300 shown in FIG. 3 according to an example. The feed list 400 can be taken as an example of the feed list mentioned in Step 320, and any of the merged feeds 410 and 420 can be taken as an example of the aforementioned feed on the specific social network. For example, the merged feed 410 is obtained from one of the related feeds of the same topic such as a first topic on the specific social network, where the upper left corner of the merged feed 410 is first labeled with “f” (which stands for Facebook in this example) and then labeled with “t” (which stands for Twitter in this example) to indicate that the specific social network under consideration is Facebook and some of the related feeds of the first topic were generated on Twitter. In another example, the merged feed 420 is obtained from one of the related feeds of the same topic such as a second topic on the specific social network, where the upper left corner of the merged feed 420 is first labeled with “t” (which stands for Twitter in this example) and then labeled with “f” (which stands for Facebook in this example) to indicate that the specific social network under consideration is Twitter and some of the related feeds of the second topic were generated on Facebook.

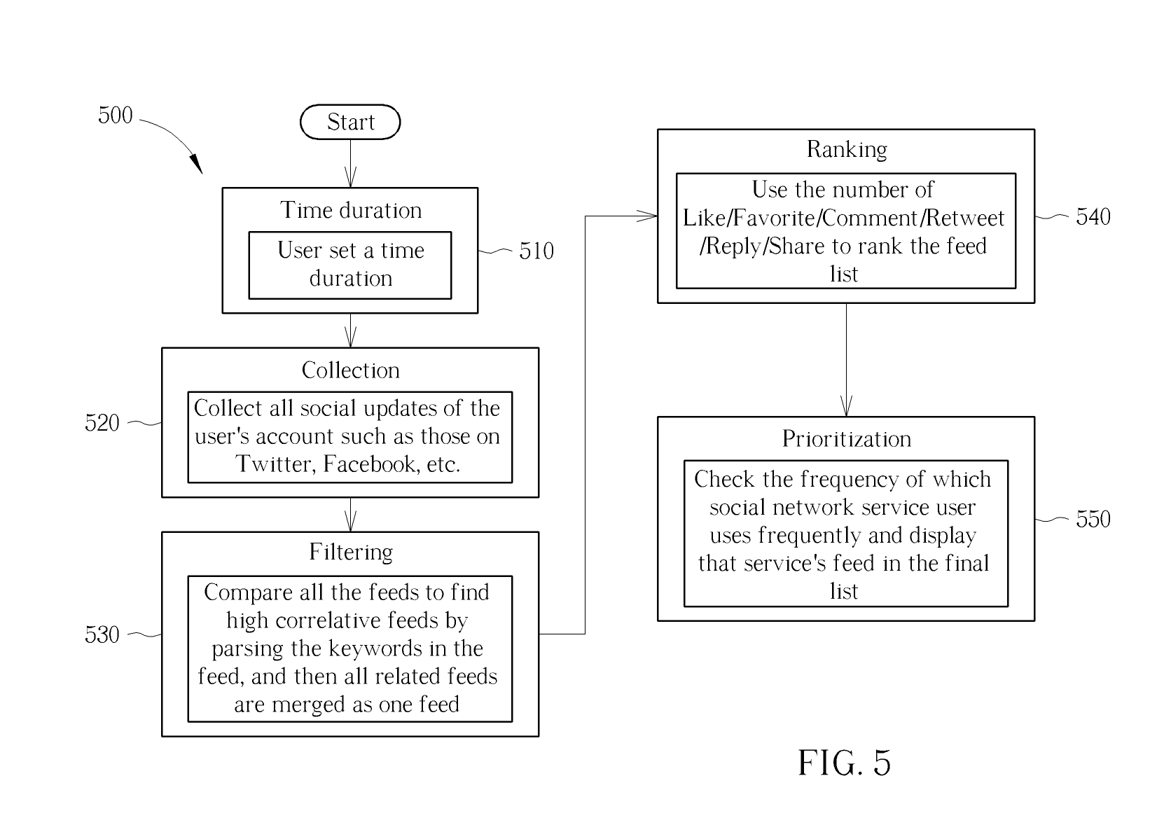

FIG. 5 illustrates a working flow 500 involved with the method 300 shown in FIG. 3 according to an example.

In Step 510, the aforementioned at least one processor 112 executing the aforementioned at least one program module 112P performs a time duration setting operation. More particularly, the aforementioned at least one processor 112 executing the aforementioned at least one program module 112P allows the user to set the time duration.

In Step 520, the aforementioned at least one processor 112 executing the aforementioned at least one program module 112P performs a collection operation. More particularly, the aforementioned at least one processor 112 executing the aforementioned at least one program module 112P collects all social updates of the user's account such as those on Twitter, Facebook, etc., the social updates generated within the time duration set in Step 510.

In Step 530, the aforementioned at least one processor 112 executing the aforementioned at least one program module 112P performs a filtering operation. More particularly, the aforementioned at least one processor 112 executing the aforementioned at least one program module 112P compares all the feeds (i.e. those collected in Step 520) to find high correlative feeds by parsing the keywords in the feed, and then all related feeds are merged as one feed, respectively.

In Step 540, the aforementioned at least one processor 112 executing the aforementioned at least one program module 112P performs a ranking operation. More particularly, the aforementioned at least one processor 112 executing the aforementioned at least one program module 112P uses the number of Like, Favorite, Comment, Retweet, Reply, or Share (more particularly, the number of feeds labeled with any of Like, Favorite, Comment, Retweet, Reply, or Share within the related feeds corresponding to the same topic) to rank the feed list.

In Step 550, the aforementioned at least one processor 112 executing the aforementioned at least one program module 112P performs a prioritization operation. More particularly, the aforementioned at least one processor 112 executing the aforementioned at least one program module 112P checks the frequency of which social network service the user uses frequently and displays that service's feed in the final list.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing merging control of feeds on at least one social network, the method being applied to an electronic device, the method comprising the steps of:
collecting all feeds of at least one account of a user of the electronic device on the at least one social network, the feeds generated during a predetermined time period, comparing the collected feeds to find related feeds corresponding to at least one same topic within the collected feeds, and merging the related feeds corresponding to the at least one same topic into at least one merged feed; and
listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.

2. The method of claim 1, wherein the step of comparing the collected feeds to find the related feeds corresponding to the at least one same topic within the collected feeds further comprises:
parsing keywords of the collected feeds to find the related feeds corresponding to the at least one same topic within the collected feeds.

3. The method of claim 1, wherein the step of comparing the collected feeds to find the related feeds corresponding to the at least one same topic within the collected feeds further comprises:
parsing Uniform Resource Locator (URL) contents shared or mentioned in the collected feeds to find the related feeds corresponding to the at least one same topic within the collected feeds.

4. The method of claim 1, wherein the step of listing the at least one merged feed and the remaining feeds within the collected feeds further comprises:
utilizing a number of feeds labeled with any of Like, Favorite, Comment, Retweet, Reply, or Share within the related feeds corresponding to the at least one same topic as a ranking index of the at least one merged feed.

5. The method of claim 4, wherein the at least one merged feed comprises a plurality of merged feeds; and within the plurality of merged feeds, a merged feed whose ranking index is greater than other(s) is ranked to be viewed by the user first.

6. The method of claim 1, wherein the at least one social network comprises a plurality of social networks; and the method further comprises:
checking frequencies of running a plurality of social network applications corresponding to the plurality of social networks on the electronic device, respectively, to determine a specific social network that the user uses more frequently than other(s) within the plurality of social networks; and
in a situation where the related feeds corresponding to the at least one same topic comprise feeds on the plurality of social networks, respectively, utilizing a feed on the specific social network, the feed corresponding to the at least one same topic, as the at least one merged feed.

7. The method of claim 1, wherein the step of merging the related feeds corresponding to the at least one same topic into the at least one merged feed further comprises:
utilizing one of the related feeds corresponding to the at least one same topic as the at least one merged feed.

8. The method of claim 1, further comprising:
providing the user with a setting mechanism, allowing the user to determine the predetermined time period in advance.

9. The method of claim 1, wherein the feed list comprises the at least one merged feed and the remaining feeds.

10. The method of claim 1, wherein in the feed list, any of the at least one merged feed and any of the remaining feeds correspond to different topics, respectively.

11. An apparatus for performing merging control of feeds on at least one social network, the apparatus comprising at least one portion of an electronic device, the apparatus comprising:
a processing circuit comprising at least one processor arranged to execute program instructions to perform operations according a method comprising the steps of:
collecting all feeds of at least one account of a user of the electronic device on the at least one social network, the feeds generated during a predetermined time period, comparing the collected feeds to find related feeds corresponding to at least one same topic within the collected feeds, and merging the related feeds corresponding to the at least one same topic into at least one merged feed; and
listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.

12. The apparatus of claim 11, wherein the step of comparing the collected feeds to find the related feeds corresponding to the at least one same topic within the collected feeds further comprises:
parsing keywords of the collected feeds to find the related feeds corresponding to the at least one same topic within the collected feeds.

13. The apparatus of claim 11, wherein the step of comparing the collected feeds to find the related feeds corresponding to the at least one same topic within the collected feeds further comprises:
parsing Uniform Resource Locator (URL) contents shared or mentioned in the collected feeds to find the related feeds corresponding to the at least one same topic within the collected feeds.

14. The apparatus of claim 11, wherein the step of listing the at least one merged feed and the remaining feeds within the collected feeds further comprises:
utilizing a number of feeds labeled with any of Like, Favorite, Comment, Retweet, Reply, or Share within the related feeds corresponding to the at least one same topic as a ranking index of the at least one merged feed.

15. The apparatus of claim 14, wherein the at least one merged feed comprises a plurality of merged feeds; and within the plurality of merged feeds, a merged feed whose ranking index is greater than other(s) is ranked to be viewed by the user first.

16. The apparatus of claim 11, wherein the at least one social network comprises a plurality of social networks; and the method further comprises:
checking frequencies of running a plurality of social network applications corresponding to the plurality of social networks on the electronic device, respectively, to determine a specific social network that the user uses more frequently than other(s) within the plurality of social networks; and
in a situation where the related feeds corresponding to the at least one same topic comprise feeds on the plurality of social networks, respectively, utilizing a feed on the specific social network, the feed corresponding to the at least one same topic, as the at least one merged feed.

17. The apparatus of claim 11, wherein the step of merging the related feeds corresponding to the at least one same topic into the at least one merged feed further comprises:
utilizing one of the related feeds corresponding to the at least one same topic as the at least one merged feed.

18. The apparatus of claim 11, wherein the method further comprises:
providing the user with a setting mechanism, allowing the user to determine the predetermined time period in advance.

19. The apparatus of claim 11, wherein the feed list comprises the at least one merged feed and the remaining feeds.

20. A computer program product, having program instructions for instructing a processor of an electronic device to perform a method comprising the steps of:
collecting all feeds of at least one account of a user of the electronic device on at least one social network, the feeds generated during a predetermined time period, comparing the collected feeds to find related feeds corresponding to at least one same topic within the collected feeds, and merging the related feeds corresponding to the at least one same topic into at least one merged feed; and
listing the at least one merged feed and remaining feeds within the collected feeds, rather than listing all of the related feeds corresponding to the at least one same topic, to generate a feed list to be viewed by the user, wherein in the feed list, the at least one merged feed is ranked to be viewed by the user first.
